(19) United States
(12) Patent Application Publication
(10) Pub. No.: US 2026/0236913 A1
(43) Pub. Date: Aug. 13, 2026

(54) SYSTEMS AND METHODS FOR ENHANCED ONLINE ACCOUNT SECURITY WITH USER-CUSTOMIZABLE SECURITY PROTOCOLS

(71) Applicant: Austin Capital Bank SSB, Austin, TX (US)

(72) Inventors: John Erik Beguin, Austin, TX (US); Elena Kraus, Round Rock, TX (US)

(21) Appl. No.: 19/531,464

(22) Filed: Feb. 5, 2026

Related U.S. Application Data
(60) Provisional application No. 63/755,146, filed on Feb. 6, 2025.

(51) Int. Cl. G06Q 20/38; G06Q 20/10

(52) U.S. Cl. CPC G06Q 20/382; G06Q 20/10

(57) ABSTRACT

Methods, systems, and apparatuses, including computer programs encoded on computer storage media, for enhanced online account security. The described techniques include maintaining data associating funds transfer request types and a secure account status with security protocols. The described techniques include receiving funds transfer requests to transfer funds among a secure account, one or more intermediate accounts, and an external account. For each request, the described techniques include determining a request type and a status for the secure account. The described techniques execute security protocols using the request and the status. In response to failing a security protocol, the described techniques generate a decision output.

### CROSS REFERENCE TO RELATED APPLICATIONS

This application claims the benefit under 35 U.S.C. § 119(e) of the filing date of U.S. Patent Application No. 63/755,146, for “SYSTEMS AND METHODS FOR ENHANCED ONLINE ACCOUNT SECURITY WITH USER-CUSTOMIZABLE SECURITY PROTOCOLS”, which was filed on 02/06/2025, and which is incorporated here by reference.

### BACKGROUND

This specification relates to methods and systems for enhanced security of online accounts by providing user-customizable security protocols for protecting transactions associated with the accounts.

As one example, the online accounts may be financial accounts, and transactions associated with those accounts may be financial transactions and associated requests.

### SUMMARY

This specification describes a system implemented as computer programs on one or more computers in one or more locations that receives one or more funds transfer requests and, for each request, generates a respective decision output.

Particular embodiments of the subject matter described in this specification can be implemented so as to realize one or more of the following advantages.

Current deposit accounts exist in a many-to-one or one-to-many funds transfer ecosystem which may expose funds to risks such as fraud and unverified access. That is, deposit accounts face varying levels of risk depending on the method of incoming funds transfer requests. For example, ACH Pull-In transactions carry a different risk profile than ACH Push-In transactions or Wire-In transfers. These different risk levels require distinct monitoring and control measures to limit unauthorized access and to maintain the integrity of the account.

This specification describes techniques that can address the aforementioned challenges. That is, this specification describes techniques that maintain data associating each of a plurality of funds transfer request types and a status of a secure account with a respective plurality of security protocols. The described techniques receive one or more funds transfer requests to transfer funds among the secure account, one or more intermediate accounts, and an external account. In some embodiments, the secure account utilizes a non-standard alphanumerical account identifier (e.g., including special characters) that is technically incompatible with external payment application fields. For each funds transfer request, the described techniques determine a funds transfer request type (e.g., by parsing metadata of the funds transfer request) and determine a status for the secure account. In response to determining the funds transfer request type and the status of the secure account, the described techniques execute one or more security protocols using the funds transfer request and the status of the secure account. In response to failing at least one of the one or more security protocols, the described techniques generate a respective decision output for the funds transfer request.

By maintaining data associating funds transfer request types and secure account statuses with security protocols, and then executing those security protocols in real-time (e.g., based on real-time status determinations), the described techniques allow for state-dependent access control that dynamically adapts to the security context needed. The described techniques can therefore automatically restrict high-risk operations (e.g., withdrawals) immediately in real-time upon detecting a security trigger (e.g., a broken link or compromised credentials), while maintaining safe operations (e.g., deposits).

By utilizing one or more intermediate accounts, including a linked intermediate account and a parallel intermediate account, to facilitate transfers between the external account and the secure account, the described techniques structurally isolate the secure account from external payment networks. Because the secure account is compatible only with the intermediate accounts and incompatible with external payment fields, the internal credentials of the secure account are never transmitted over external payment rails, which prevents the secure account identifier from being scraped, intercepted, or targeted by malicious actors on a public network.

By generating a unique account identifier associated with a parallel intermediate account and identifying if a request directed to that account is a debit request, the described techniques enforce a strict “unidirectional flow” of funds. Such a technique can address problems such as credential replay attacks because the exposed unique account identifiers are computationally restricted to act as ingress-only nodes. For unauthorized data extraction (e.g., withdrawal), the identifiers pose no security risk (even if the identifiers are stolen or exposed publicly).

In particular, the described techniques improve the security of deposit accounts by executing risk-appropriate security protocols, including custom user-defined security protocols, to evaluate funds transfer requests and generate a decision output determining whether to honor or deny the request. The described techniques provide a secure solution through the use of many features.

For example, by using distinct account statuses for a secure account (e.g., including but not limited to ‘PROTECTED’ status and ‘LOCKDOWN’ status), as well as comprehensive verification processes for incoming and outgoing transfer transactions, the described techniques enhance overall security by having an extra layer of verification to mitigate potential risks.

As another example, by categorizing and tracking all incoming funds transfer requests into distinct categories, the described techniques provide specific protections that align with the risk-level associated with each type of transaction.

As another example, by using “account cloaking for all funds transfers” (i.e., funds transfers can only be allowed to or from a single external account to a secure account through intermediate accounts), the described techniques isolate funds transfers and reduce direct exposure to potential risks.

As another example, by allowing end-to-end funds transfer to only one external account to or from a secure account, the described techniques minimize exposure to unauthorized transactions and simplifies monitoring potential risks.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1A shows an example secure transaction system.

FIG. 1B shows an example secure transaction system transferring funds from an external account to a secure account.

FIG. 1C shows an example secure transaction system transferring funds from a secure account to an external account.

FIG. 1D shows an example secure transaction system depositing funds from a third-party entity into a secure account.

FIG. 2 is a flow diagram of an example process for processing a funds transfer request.

FIG. 3A shows an example of a user interface display.

FIG. 3B shows an example of a user interface display.

FIG. 3C shows an example of a user interface display.

FIG. 4 shows an example computer system.

Like reference numbers and designations in the various drawings indicate like elements.

### DETAILED DESCRIPTION

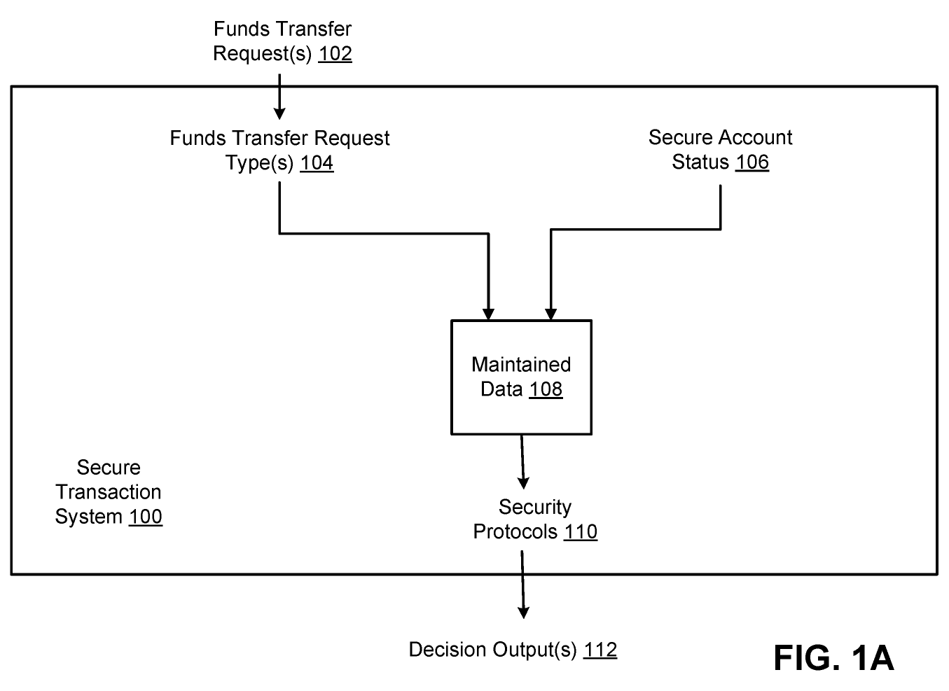

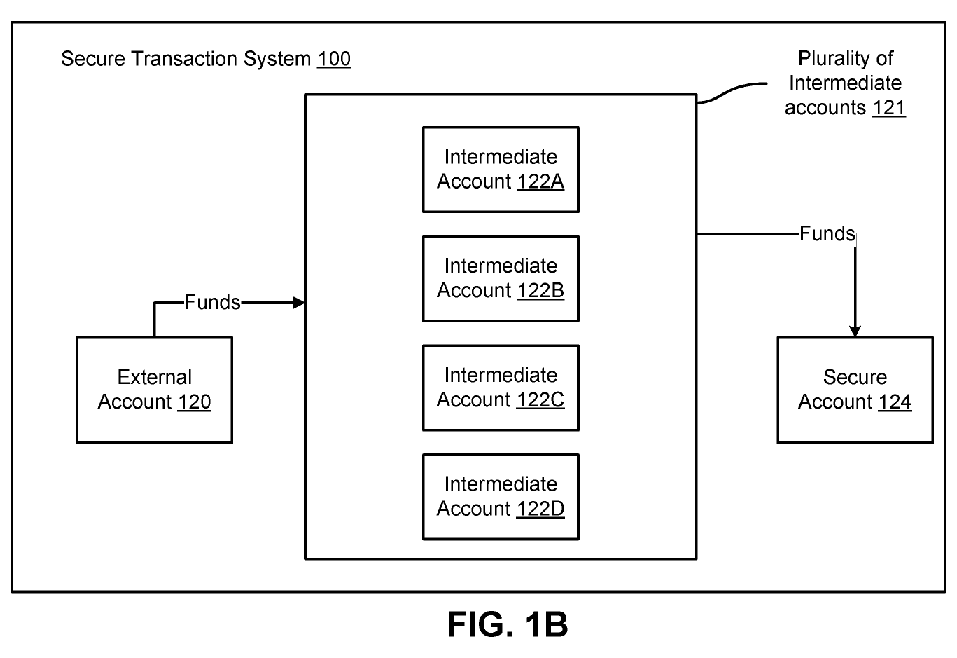

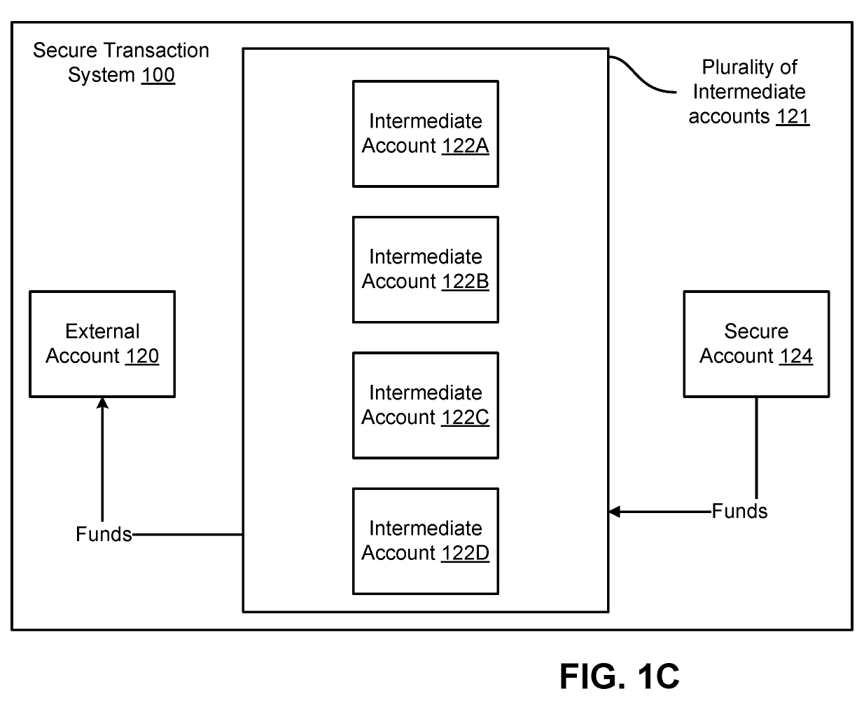

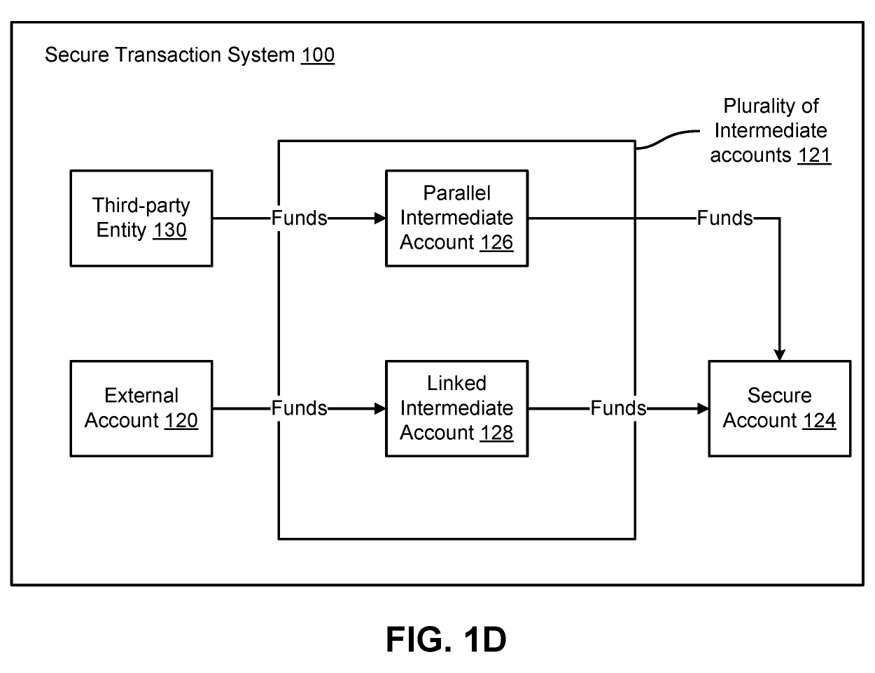

FIG. 1A shows an example secure transaction system 100. The secure transaction system 100 is an example of a system implemented as computer programs on one or more computers in one or more locations, in which the systems, components, and techniques described below can be implemented.

The system 100 is a system that receives one or more funds transfer requests 102, and in response, generates respective one or more decision outputs 112.

That is, the system 100 receives one or more funds transfer requests 102 that are requests to transfer funds between pairs of accounts among a secure account, one or more intermediate accounts, and an external account. Then, the system 100, for each request 102, executes one or more security protocols 110 and, in response to failing at least one of the one or more security protocols 110, generates a respective decision output 112 that denies the funds transfer request, or places the funds transfer request in a pending status requiring additional protocols or reviews to make a determination to deny or approve the request in whole or in part. Additionally, the system 100, in response to passing all the one or more security protocols 110, generates a respective decision output 112 that allows the funds transfer request 102.

Generally, each funds transfer request 102 includes at least account information, a transfer amount, and metadata. The account information includes the participating accounts for the transfer, e.g., an external account, an intermediate account, and/or a secure account. The transfer amount is the specific amount of funds to be transferred. Additionally, the metadata can include any of a variety of types of information associated with the request 102. For example, the metadata can include a memo, a timestamp, electronic signature, payor name, payee name, account ownership, financial institution identifier, method of transfer, timing of transfer, codes, messages, and so on.

Furthermore, the security protocols 110 can be any of a variety of appropriate security protocols that can verify the integrity and legitimacy of the funds transfer request. As one example of a security protocol 110, the system 100 can verify that the payee’s name matches the intended recipient according to the transfer request 102 metadata.

In some implementations, the system 100 receives user-customized security protocols. That is, the system 100 receives from a user a user-designed security protocol that the system 100 can then subsequently use as a security protocol 110.

Further details of the security protocols 110 are described below.

The respective decision outputs 112 each include information of whether the funds transfer request 102 is allowed or denied and are signals or data (e.g., instructions) that the system 100 can provide to a user or another system.

For example, the system 100 can provide a decision output 112 that includes a denial of a funds transfer request to a fraud investigation team member through an end-user device display.

As another example, the system 100 can provide a decision output 112 that includes a denial of a funds transfer request to an anti-fraud system integrated into a financial institution’s funds transfer processing workflow (i.e., another system).

Further details of the decision output 112 are described below.

In particular, the system 100 maintains data 108 associating each of a plurality of funds transfer request types 104 and a secure account status 106 of a secure account with a respective plurality of security protocols 110.

In some implementations, when the system 100 receives user-customized security protocols, the user-customized security protocols are a subset of the security protocols 110 of the system’s 100 maintained data 108.

In some implementations, “receiving user‑customized security protocols” refers to the system 100 ingesting, from a user, selections and/or configurations that tailor which security protocols 110 are enforced and how those protocols operate for that user’s accounts and transaction flows. The user‑customized security protocols are normalized by the system into canonical protocol identifiers and parameter values that correspond to protocol definitions already represented in the system’s maintained data 108. Thus, the user‑customized security protocols do not introduce arbitrary executable logic; rather, they select from, enable/disable, prioritize, or parameterize members of the existing catalog of security protocols 110 such that the resulting set is a subset of the security protocols 110 already available to the system 100.

In some implementations, user‑customized security protocols include (a) selection of particular protocol types from a catalog (e.g., enabling “device fingerprint verification” and “geofencing” while disabling “dual‑layer biometrics”), (b) parameterization of protocol thresholds and windows (e.g., setting a maximum transaction cap, specifying allowed time‑of‑day windows, or enumerating approved geofenced regions), (c) prioritization or ordering rules that define the sequence in which security protocols 110 are executed or which protocols are treated as “hard fail” versus “advisory,” and (d) scoping directives that bind customized protocols to specific funds transfer request types 104 and/or account statuses 106.

In some cases, user‑customized security protocols support role‑based control and account‑level scoping. For example, an account owner may customize protocols for their secure account, whereas an enterprise administrator may define organization‑wide defaults and then allow per‑account refinements. The system 100 can encode precedence rules such that organization‑mandated protocols (e.g., “Lockdown Enforcement” for withdrawals) are non‑overridable, whereas other protocols (e.g., “biometric challenge for amounts above $X”) are user‑tunable.

The system 100 then receives one or more funds transfer requests 102 to transfer funds between (i) the secure account and an intermediate account, or (ii) an external account and the secure account, (iii) the external account and the intermediate account.

Generally, the secure account is designed to be compatible with only the system 100 (i.e., is designed to not be compatible or communicate with any other system, e.g., a third party funds transfer system or payment system), and all funds transfers associated with the secure account only occur with an intermediate account that may be compatible with external funds transfer and payment systems.

For example, the secure account may have features that are incompatible with or differ from traditional deposit accounts, e.g., the secure account does not have account identifiers that follow the common rules of other deposit accounts.

As a particular example, the secure account may have an alphanumerical account identifier including special characters that cannot be used with external payment applications or other funds transfer systems.

Generally, the intermediate account facilitates funds transfers between the external account and the secure account. That is, the intermediate account serves as an intermediary layer to enhance funds transfer security. For example, in order for funds to transfer from the secure account to the external account the system 100 can require processing a first request to transfer funds from the secure account to the intermediate account before the system 100 processes a second request to transfer funds from the intermediate account to the external account. In other words, the intermediate account only holds funds in order to honor an end-to-end transfer of funds from a secure account to an external account. For the converse transfer of funds from the external account to the secure account, the system 100 can require a request to transfer funds from the external account to the intermediate account. Then the system 100 can sweep the funds transferred into the intermediate account into the secure account at a designated frequency, e.g., hourly, daily, weekly, and so on, so that, again, the intermediate account only holds funds in order to honor an end-to-end transfer.

The intermediate account can be, for example, a ‘For Benefit Of’ (FBO) account (i.e., an account that an account custodian can manage the funds of for another entity or individual) that the system uses to process funds transfer from the external account to the secure account.

In some implementations, the system 100 is configured to use a plurality of intermediate accounts.

For example, a first intermediate account can be designated for receiving funds from the external account and then sending funds to the secure account, and a second intermediate account can be designated for receiving funds from the secure account and then sending funds to the external account or allowing an external account financial institution to debit the intermediate account.

As another example, a sequence, series, or structured group of intermediate accounts can be used to structure the funds transfer in a user defined configuration for enhanced security, tracking, reporting, regulatory, legal, accounting, or other purposes. That is, a plurality of intermediate accounts can facilitate funds transfer in a manner that corresponds to a user defined composability of the intermediate accounts for any of a variety of purposes. As one example, a funds transfer between account A and account E can be facilitated by intermediate accounts B, C, D according to a user defined configuration such that funds transfer first occurs between accounts A and B, then between accounts B and C, then between accounts C and D, and finally between accounts D and E.

In some implementations, the system 100 categorizes the intermediate accounts into distinct types to manage ingress paths. For example, the system 100 may utilize a “linked” intermediate account that is specifically associated with the external account and a “parallel” intermediate account that is distinct from the linked intermediate account. The parallel intermediate account (also referred to as a Secure Deposit Number or “SDN” account) can be configured to accept funds from third-party sources distinct from the external account.

To facilitate this parallel ingress, the system 100 may generate unique account identifiers (e.g., routing and account number pairs) associated with the parallel intermediate account. In some cases, the system 100 generates a plurality of unique account identifiers for the same parallel intermediate account and maps each unique identifier to a different third-party entity (e.g., a specific employer or government agency).

In some cases, for the parallel intermediate account, the system 100 is configured to detect a receipt of funds from the third-party source and automatically generate a transfer request to move the funds from the parallel intermediate account to the secure account. This auto-sweep function ensures that the parallel intermediate account operates as a custodial pass-through, bypassing the need for the user to route funds through the external account.

Generally, the external account can be any of a variety of account types and does not have the same restrictions as the secure account or intermediate account. That is, the external account can include, as examples, bank deposit accounts, digital wallets, payment platforms, and so on, and can belong to other systems outside of, in addition to, the system.

In some implementations, if the funds transfer request includes the pair of accounts that is the secure account and the external account, the system 100 prohibits direct funds transfer. Instead, the system 100 dynamically creates one or more intermediate accounts that are used exclusively to facilitate funds transfer between the secure account and the external account; and the system 100 dynamically creates one or more funds transfer requests that utilizes the dynamically created intermediate accounts to process in place of the original funds transfer request between the secure account and the external account. The system 100 can create the one or more intermediate accounts and the one or more funds transfer requests in place of the original funds transfer request based on default system rules or user-created rules.

In this specification, the term “funds transfer request” is used to encompass both an initial request received from an external source (e.g., a client device) and any subsequent, system-generated transfer instructions required to facilitate the movement of funds between intermediate accounts. Accordingly, the system 100 treats each discrete movement of funds (whether externally initiated or internally generated) as a distinct “funds transfer request” subject to the security protocols 110 and decision outputs 112 described below.

The system 100 can receive funds transfer requests 102 through any of a variety of means, e.g., through a network connection, e.g., a cloud-based network, the internet, or a local network. For example, an internet network connection can facilitate the system receiving the funds transfer request through an API call.

In some implementations, the funds transfer request is initiated by a user interacting with a client device (e.g., a smartphone, tablet, or laptop) running a dedicated application or web browser. The client device can communicate with the system 100 over the network to transmit the request and display subsequent notifications or decision outputs.

In some cases, the system 100 processes funds transfer requests 102 that are encrypted to ensure security. For example, the system 100 may process requests 102 that use traditional encryption (i.e., encryption schemes resistant to attacks from non-quantum computers, e.g., RSA, AES, or ECC encryption) or post-quantum encryption (i.e., encryption schemes resistant to attacks from quantum computers).

Next, the system 100, for each funds transfer request 102, performs the following.

The system 100 determines a funds transfer request type 104 for the funds transfer request 102.

The funds transfer request types 104 categorize any digital requests for moving funds between accounts or financial institutions. For example, the funds transfer request types 104 can categorize funds transfer requests 102 that adhere to specific payment network protocols, e.g., Society for Worldwide Interbank Financial Telecommunication (SWIFT), Fedwire Funds Service, or automated clearing house (ACH) networks.

Generally, the system 100 can determine the funds transfer request type 104 from the funds transfer request 102, particularly using metadata included in the funds transfer request 102.

For example, the metadata of a funds transfer request 102 can include an ACH routing number, a Standard Entry Class (SEC) code, e.g., ‘WEB’, a transaction type string, e.g., ‘single entry debit’, which the system uses to determine the funds transfer request is an “ACH Pull-In”.

The system 100 also determines a status 106 for the secure account. That is, the system 100, e.g., continuously determines the status 106 of the secure account by processing real-time data.

For example, the system 100 can retrieve and process real-time data, e.g., from another system (e.g., a transaction processing system, a financial institution database, and so on). The retrieved real-time data can be, for example, status category values, e.g., “PROTECTED” or “LOCKDOWN”, or can be data that can be further processed to determine status category values.

As a particular example, the system 100 may establish a secure link to an external account and continuously monitor the link and the activity of the linked external account, to detect any security triggers and, in response to detecting a security trigger for the link or external account, the system 100 updates a maintained status value of the secure account and determines the status 106 of the secure account as the updated status value. For example, the system 100 can update the status 106 of the secure account from ‘PROTECTED’ to ‘LOCKDOWN’ in response to a detected security trigger, such as failed aggregation attempts, a broken or disrupted secure link, transaction discrepancies, or suspicious transfer or transaction activities.

There can be any number of status 106 values for the secure account. In some implementations, the status 106 includes only ‘PROTECTED’ and ‘LOCKDOWN’. In other implementations, that status includes 3, 30, 300, or unlimited status values.

The system 100, in response to determining the funds transfer request type 104 and the status 106 of the secure account, executes one or more security protocols 110 using the funds transfer request 102 and the status 106 of the secure account. Then, the system 100, in response to failing at least one of the one or more security protocols 110, generates a respective decision output 112 that denies the funds transfer request 104.

Some examples of security protocols 110 follow.

For example, the security protocol 110 can include verifying that the funds transfer request 102 adheres to deposit and withdrawal limits associated with the fund transfer type 104.

As a particular example, the funds transfer type “ACH Pull-In” can be limited to pre-authorized amounts, and the security protocol 110 can include ensuring that a funds transfer ACH Pull-In type adheres to the pre-authorized amounts.

As another particular example, the funds transfer types “ACH Push-In” and “Wire-In” can be subject to transaction monitoring, low velocity limits (i.e., low number of allowed transactions) and transaction caps (i.e., limited total funds that can be transferred). The security protocol 110 can then include ensuring that funds transfer requests 102 that are ACH Push-In and Wire-In fund transfer types 104 adhere to velocity limits and transaction caps.

As another example, the security protocol 110 can include transaction monitoring and verification.

As a particular example, the security protocol 110 can include verifying that the continuous monitoring of the external account satisfies aggregation integrity and transaction consistency.

As another particular example, the security protocol 110 can include daily scheduled transaction validation of the external account.

As another particular example, the security protocol 110 can include checking for unverified transactions not originating from the external account.

As another example, the security protocol 110 can include verifying the current and/or past, ownership of the external account. As a particular example, the security protocol can include verifying if the account is associated with changes in ownership.

As another example, the security protocol 110 can include money movement restrictions.

As a particular example, the system 100 can apply distinct security protocols 110 based on the account type. For example, the security protocol 110 for a parallel intermediate account (SDN) can include identifying if a received request is a deposit request or a debit request. If the request is identified as a debit request, the system 100 automatically generates a decision output 112 that denies the request. This example security protocol enforces a “deposit-only” restriction, allowing the account identifier to be shared publicly without risk of unauthorized withdrawal.

As a particular example, for funds transfer request 102 to transfer to the secure account, the security protocol 110 can include verifying that the request 102 includes transferring funds from the pre-verified external account.

As another example, the security protocol 110 can include enhanced authorization requirements.

As a particular example, the security protocol 110 can include requiring explicit account owner authorization to affirm account limits and approve specific transfer origins.

As another particular example, the security protocol 110 can include multi-factor authentication steps, including biometric or password confirmation from a secure account owner, for outbound funds movement.

As another example, the security protocol 110 can include advanced identity verification and multi-layered authentication, e.g., location-based authentication and geofencing, biometric verification for access and transaction authorization, in-person and/or witnessed identity verification, and external bank account ownership and transactional analysis.

As a particular example, the security protocol 110 can include using geolocation data to verify that the funds transfer request 102 point (i.e., geolocation of the secure account owner at the time of initiating a funds transfer request) aligns with the secure account owner’s established usage patterns.

As another particular example, the security protocol 110 can include the system 100 confirming the secure account holder’s identity by matching their current location with geofenced areas (such as home, work, or other routine areas for the secure account holder).

As another particular example, the security protocol 110 can include dual-layer biometric authentication that includes both facial recognition and identification card scanning which is matched against stored biometric data and verified with stored government-issued identification card.

As another particular example, the security protocol 110 can include extensive external bank account verification by analyzing the external account’s ownership, account history, and transactional patterns.

As another particular example, the security protocol 110 can include reviewing the history of the external bank account for length of account activity, consistency in balance, and typical transaction types. Then the system references a profile of average balances and daily transaction patterns to flag any significant deviations.

As another example, the security protocol 110 can include behavioral and temporal analysis of account access.

As a particular example, the security protocol 110 can include assessing if a funds transfer request is initiated outside established patterns stored in a behavioral profile based on the secure account owner’s typical transaction behavior.

As another particular example, the security protocol 110 can include assessing if a funds transfer request is initiated outside user defined transaction windows.

As another example, the security protocol 110 can include device fingerprinting and anomaly detection.

As a particular example, the security protocol 110 can include verifying that a funds transfer request originates from a device that is consistent with a stored device profile associated with the secure account that includes device attributes, such as operating system, browser type, and screen resolution.

As another particular example, the security protocol 110 can include fingerprint verification request on an end-user device.

Some examples of uses of decision outputs 112 follow.

As an example of using the decision output 112, the system 100 can deny the funds transfer request 102, e.g., the decision output causes the system to provide an error code in response to an API call or the system 100 terminating one or more software processes. In other words, the system 100 does not perform actions that the funds transfer request 102 needs in order to be completed.

As another example of using the decision output 112, the system 100 uses the decision output 112 to perform security escalation in response to a decision output 112 that denies the funds transfer request 102.

As a particular example, the system 100 uses the decision output 112 to notify the owner of the secure account (e.g., through an end-user device via a smart-phone notification, a phone call, a text-message, or an email) of the failed security protocols.

As another particular example, the system 100 uses the decision output 112 to generate a report and send the report to security teams or other automated systems to address security threats.

As another particular example, the system 100 uses the decision output 112 to update the secure account status value 106, e.g., the system 100 can update the status 106 of “PROTECTED” to “LOCKDOWN”.

As another particular example, the system 100 uses the decision output 112 to update the data associating each of a plurality of funds transfer request types 104 with a respective plurality of security protocols 110 such that the associated protocols are updated.

While a few particular examples of security protocols 110 and system 100 uses of decision outputs 112 are given above, the described techniques can be to apply any of a variety of security protocols 110 and the system 100 can use the decision outputs 112 for any of a variety of purposes.

With these examples illustrating security protocols and uses of decision outputs, attention is directed back to the initial description of how the system operates.

The system 100, in response to passing all the one or more security protocols 110, generates a respective decision output 112 that allows the funds transfer request 102.

FIG. 1B shows an example secure transaction system 100 transferring funds from an external account 120 to a secure account 124.

As shown in FIG. 1B, the system 100 utilizes one or more intermediate accounts 122A-D to facilitate the transfer, ensuring no direct link exists between the external account 120 and the secure account 124.

In this example “deposit” scenario, funds originate at the external account 120 and are transferred to a first intermediate account (e.g., intermediate account 122A) of the plurality of intermediate accounts 121. This first intermediate account 122A is a linked intermediate account specifically associated with the external account 120. The system 100 can maintain verification data to enforce a closed-loop security model, ensuring that the first intermediate account 122A accepts funds exclusively from the pre-verified external account 120 and rejects transfers from unverified third-party sources.

Once funds are received in the linked intermediate account 122A, the system 100 may subject the transaction to various security protocols 110 (as described above) before processing a subsequent funds transfer request 102 to move the funds from the linked intermediate account 122A to another intermediate account (e.g., intermediate account 122B) within the plurality of intermediate accounts 121.

The system 100 continues to process funds transfer requests 102 between subsequent intermediate accounts (e.g., from intermediate account 122B to intermediate account 122C, and from intermediate account 122C to intermediate account 122D), executing one or more security protocols 110 at each stage or at selected stages of the transfer chain. This sequential movement ensures that funds are passed through a layered security structure where the funds may be held or analyzed before proceeding. The movement of funds between these accounts may occur in real-time or according to a designated schedule (e.g., daily sweeps), ensuring that the intermediate accounts 122A-D hold funds only for the duration required to clear the transaction. Upon successfully passing all applicable security protocols 110 throughout the chain of intermediate accounts 122A-D, the system 100 executes a final funds transfer request 102 to move the funds from the final intermediate account (e.g., intermediate account 122D) to the secure account 124.

However, if the system 100 determines that a funds transfer request 102 fails at least one of the one or more security protocols 110 at any stage in this sequence, the system 100 generates a respective decision output 112 that denies the funds transfer request 102 (as described above). Consequently, the system 100 may halt the progression of funds, return the funds to the external account 120, or place the funds in a holding state for manual review, thereby preventing potential security threats from reaching the secure account 124.

The multi-step process shown in FIG. 1B effectively “cloaks” the secure account 124 identifier from the external banking infrastructure of the external account. Because the external account 120 interacts only with the first intermediate account 122A, the specific alphanumerical account identifier of the secure account 124 remains unexposed to the financial institution managing the external account 120.

FIG. 1C shows an example secure transaction system 100 transferring funds from a secure account 124 to an external account 120.

In this example “withdrawal” process, the system 100 receives a funds transfer request 102 to move funds from the secure account 124 to a linked intermediate account (e.g., intermediate account 122D). The system 100 then processes subsequent funds transfer requests 102 to move the funds through a sequence of one or more intermediate accounts (e.g., from intermediate account 122D to intermediate account 122C, and so on).

As the system 100 processes these funds transfer requests 102, it executes one or more security protocols 110 at selected stages of the transfer chain to verify the legitimacy of the withdrawal. For example, the system 100 may enforce a temporal security protocol during this sequence, such as requiring a mandatory holding period (e.g., two business days) within the intermediate accounts before authorizing the final release of funds. Additionally, the security protocols 110 may include transaction monitoring to ensure the request adheres to velocity limits and transaction caps associated with the Secure Account 124.

During this process, the system 100 verifies that the destination identifier of the external account 120 matches the specific pre-verified account authorized for the closed-loop security model. Any request to route funds to a different or unverified external destination is automatically denied. The funds are held in the intermediate accounts only for the duration necessary to process the transfer and satisfy the applicable security protocols 110. Upon reaching the final linked intermediate account in the sequence and passing all applicable security protocols 110, the system 100 executes a final funds transfer request 102 to move the funds from the linked intermediate account to the external account 120 (e.g., intermediate account 122A).

This example shows that the secure account 124 never directly pushes funds to an external destination, thereby preventing exposure of its private credentials in external payment networks.

FIG. 1D shows an example secure transaction system 100 depositing funds from a third-party entity 130 into a secure account 124.

Unlike the transfers of FIGS. 1B and 1C which utilize a linked intermediate account 128 (the intermediate account specifically associated with the external account 120), and which may correspond to the first intermediate account 122A described in FIG. 1B, this operation utilizes a parallel intermediate account 126. The parallel intermediate account 126 is distinct from the linked intermediate account 128 and is configured to accept funds from a source distinct from the external account 120, such as a third-party entity 130 (e.g., an employer, government agency, or peer-to-peer payor). In some implementations, the parallel intermediate account 126 functions as a custodial or “For Benefit Of” (FBO) account managed by the system 100.

The system 100 can generate one or more unique account identifiers (e.g., distinct routing and account number pairs) associated with the parallel intermediate account 126 and store mapping data in the maintained data 108 associating each identifier to a specific third-party entity 130. This allows a specific third-party entity 130 to deposit funds without accessing the user’s primary external account 120 or secure account 124. Upon detecting a receipt of funds in the parallel intermediate account 126, the system 100 can automatically generate a funds transfer request 102 to sweep the funds from the parallel intermediate account 126 to the secure account 124.

The system 100 can apply specific security protocols 110 to this parallel path to prevent unauthorized access. For example, the security protocols 110 may include identifying if a request directed to the parallel intermediate account 126 is a debit request and automatically generate a decision output 112 that denies such a request, thereby enforcing a “deposit-only” security model for public-facing identifiers.

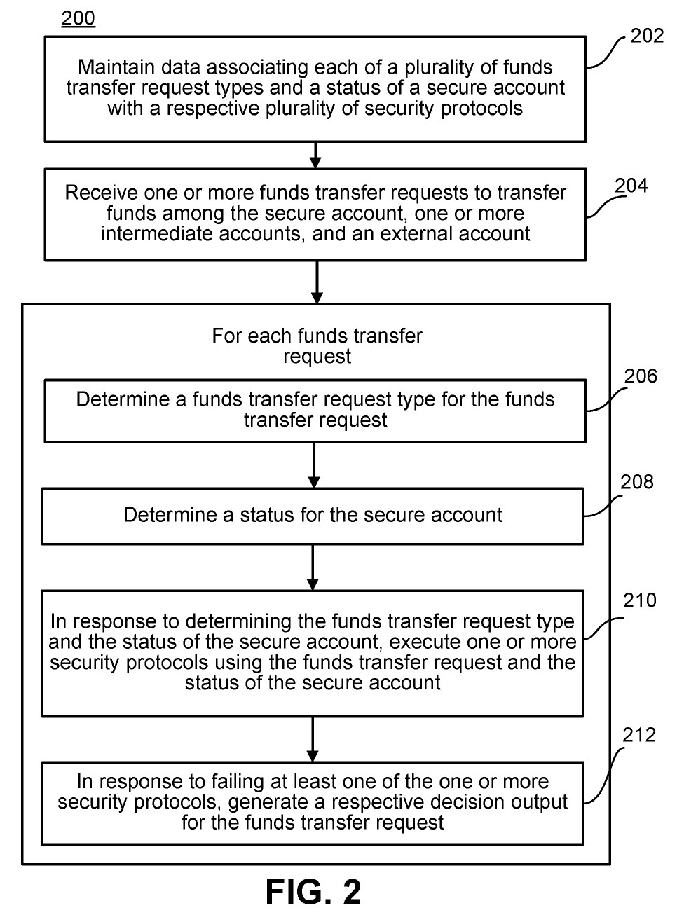

FIG. 2 is a flow diagram of an example process 200 for processing a funds transfer request. For convenience, the process will be described as being performed by a system of one or more computers located in one or more locations. For example, a secure transaction system, e.g., the secure transaction system 100 of FIG. 1A, appropriately programmed in accordance with this specification, can perform the process 200.

The system maintains data associating each of a plurality of funds transfer request types and a status of a secure account with a respective plurality of security protocols (operation 202).

The secure account can be a specialized asset storage account designed to be incompatible with external payment networks to maximize security. In some implementations, the secure account is identified by a non-standard account identifier, such as an alphanumerical string including special characters (e.g., “as;d*)4)(&!=scokom”), which cannot be processed by standard Automated Clearing House (ACH) or wire transfer fields. Because of this incompatibility, the secure account relies entirely on the system’s intermediate accounts (e.g., linked intermediate accounts and parallel intermediate accounts) to facilitate transfer of funds.

The funds transfer request types can be categorized, for example, by the payment rail utilized (e.g., payment platforms or a payment networks that moves money from a payer to a payee), and the direction of flow (e.g., Push-In, Pull-In, Push-Out). For example, specific request types may include a “Linked Account Deposit” (e.g., funds originating from the pre-verified external account directed to a linked intermediate account) and a “Parallel Ingress Deposit” (e.g., funds originating from a third-party entity directed to a parallel intermediate account or SDN).

The status of the secure account can be determined based on real-time monitoring of the secure account and its associations. Example status values include “PROTECTED” (indicating normal operation where the link to the external account is verified and active) and “LOCKDOWN” (indicating a security event, such as a broken data link to the external account 120, failed authentication attempts, or suspicious velocity patterns). The maintained data maps these status values to specific restriction levels; for instance, a “LOCKDOWN” status may trigger a protocol that automatically rejects all withdrawal requests while permitting specific types of deposit requests.

The security protocols can include a diverse set of rules engines and verification scripts tailored to the specific intermediate account utilized. For linked intermediate accounts, the protocols may include “Source Verification” (e.g., verifying the funds originate from the specific linked external account). For parallel intermediate accounts, the protocols may include “Debit Blocking” (e.g., identifying and denying any debit/withdrawal requests to enforce a deposit-only model) and “Payor Mapping Verification” (e.g., ensuring the incoming funds match the third-party entity mapped to the specific unique account identifier used). Other protocols may include transaction velocity limits, biometric authentication challenges, geolocation verification (e.g., geofencing), and temporal holding periods.

In operation 202, the system can act as a central policy engine, maintaining a rules database or lookup table that defines how these variables interact. The system stores configuration data that links specific combinations of inputs to required actions. For example, the system 100 may maintain a rule stating: IF [Request Type = “Parallel Ingress Deposit”] AND [Secure Account Status = “PROTECTED”], THEN EXECUTE [“Debit Block Protocol”, “Auto-Sweep Protocol”].

The system can also maintain a mapping table that links generated unique account identifiers (SDNs) for the parallel intermediate accounts to specific third-party entities. For example, the system can record that Identifier A is assigned to “Employer X” and Identifier B is assigned to “Government Agency Y.” This maintained data allows the system to validate incoming fund transfer requests not just against general security rules, but against specific user-defined permissions.

Further, the system can update this maintained data dynamically. If a security protocol fails during a transaction (e.g., a debit is attempted on a parallel intermediate account), the system can update the status of the secure account from “PROTECTED” to “LOCKDOWN” in the maintained data. This state change ensures that subsequent requests can be subjected to heightened scrutiny or automatic denial until the security trigger is resolved.

The system receives one or more funds transfer requests to transfer funds among the secure account, one or more intermediate accounts, and an external account (operation 204). The funds transfer occurs between at least one first account and at least one second account, where the first account and second account are distinct.

In some cases, the one or more intermediate accounts includes a linked intermediate account associated with the external account and a parallel intermediate account distinct from the linked intermediate account.

That is, the system can utilize distinct types of intermediate accounts to support different funds transfer requests. For example, a “linked intermediate account” can serve as a dedicated node for transfers involving a user’s pre-verified external account (a closed-loop path). In contrast, a “parallel intermediate account” (or SDN account) can be configured to accept funds from third-party sources.

In some cases, the system generates a unique account identifier associated with the parallel intermediate account. The system also maps the unique account identifier to a specific third-party entity.

In some cases, the system generates a plurality of unique account identifiers associated with the parallel intermediate account and maps each of the plurality of unique account identifiers to a different third-party entity. That is, the system can generate and assign distinct ingress addresses for different payors, all of which route funds to the same underlying secure account. For example, a user may generate a first unique routing/account number pair assigned exclusively to “Employer Payroll” and a second unique routing/account number pair assigned exclusively to “Tax Refunds.” The system maintains a mapping table in the maintained data linking these distinct identifiers to the user’s parallel intermediate account. This configuration provides granular security; if the “Employer Payroll” identifier is compromised, the system can revoke that specific identifier without disrupting the “Tax Refunds” identifier or the underlying secure account.

Intermediate accounts, in some cases, hold funds temporarily and only for the duration required to clear the transaction or satisfy a security holding period.

An external account can be any financial repository. This includes traditional demand deposit accounts (e.g., checking or savings accounts at third-party banks), digital wallets, or payment platform accounts. The system classifies external accounts based on their verification status. A “linked external account” is a specific account that has undergone strict ownership verification (e.g., via micro-deposits or instant account aggregation) and is authorized for bidirectional funds movement with a linked intermediate account.

In operation 204, the funds transfer request may originate from a user interaction (e.g., a user interacting with a client device, e.g., a user tapping “Deposit” on a mobile application user interface) or from an external network event (e.g., an incoming ACH file transmission from the Federal Reserve or a real-time payment message). The received request can include a payload specifying the source identifier, the destination identifier, and the amount.

During operation 204, the system can identify which specific intermediate account is being targeted by the request.

In some cases, when the system receives the one or more funds transfer requests, the system receives a deposit request directed to the parallel intermediate account from a source distinct from the external account.

In some implementations, the system detects a receipt of funds in the parallel intermediate account. The system can then automatically generate a transfer request to move the funds from the parallel intermediate account to the secure account.

For example, a user may provide a generated SDN (associated with a parallel intermediate account) to their employer for direct deposit. When the employer initiates an ACH credit transaction to that SDN, the system receives the incoming funds into the parallel intermediate account (which may act as a custodial/FBO holding account). Upon confirmation of receipt, the system immediately triggers an internal book transfer to sweep those funds from the parallel intermediate account directly into the secure account.

For each funds transfer request, the system performs operations 206-212.

The system determines a funds transfer request type for the funds transfer request (operation 206).

As an example, the system 100 analyzes specific data fields within the funds transfer request metadata to determine its type. For example, the system examines the Standard Entry Class (SEC) code and the Transaction Code (e.g., Automated Deposit, Automated Payment) provided in an ACH file included in the metadata. The system 100 can cross-reference the destination account number against its internal database of intermediate accounts.

The system determines a status for the secure account (operation 208).

The status for the secure account can be a dynamic state variable maintained by the system. An example a status value can be “PROTECTED” (indicating normal operation where all security checks are passing and the link to the external account is verified active). Another example status value can be “LOCKDOWN” (indicating a critical security event has been detected by the system). Additional status values may include “RESTRICTED” (e.g., allowing deposits but blocking withdrawals) or “PENDING REVIEW” (e.g., requiring manual operator intervention before processing).

In some implementations, the system continuously monitors the external account for security triggers. The system can, in response to detecting a security trigger for the external account, update the status of the secure account.

For example, the system can maintain an API connection to a financial institution hosting the linked external account. If that financial institution broadcasts a notification that the external account’s login credentials have been compromised or that the account is under investigation for fraud, the system can immediately detect this as a trigger. In response, the system can update the status of the secure account from “PROTECTED” to “LOCKDOWN”.

In operation 208, the system can retrieve the current status value to determine if a requested funds transfer transaction can proceed. This check can act as a “gatekeeper” step before the specific security protocols of operation are executed. For example, the system can be configured to, if the status is “LOCKDOWN,” automatically deny any funds transfer request types that involve outbound movement of funds.

In some cases, the system can also update the status based on activity associated with intermediate accounts.

For example, for a parallel intermediate account, if the system detects a high volume of unauthorized debit attempts from the parallel intermediate account, the system could update the secure account status to be “LOCKDOWN” (or a specific “SDN-COMPROMISED” status).

In some implementations, the maintained data includes a protocol mapping structure that associates each ordered pair consisting of a determined funds transfer request type and a determined secure account status with a protocol set identifier that resolves to one or more security protocols. After operations 206 and 208 determine the funds request type and the secure account status, the system constructs a composite lookup key, queries the maintained data (e.g., a data store) using an index keyed to that composite, and retrieves the security protocol set mapped to that exact combination. The retrieved identifier is dereferenced to a concrete set of protocol definitions and parameters that are then executed in operation 210 against the current funds transfer request. Thus, in some cases, the system can retrieve one or more security protocols from maintained data by querying the maintained data.

The system, in response to determining the funds transfer request type and the status of the secure account, executes one or more security protocols using the funds transfer request and the status of the secure account (operation 210).

For example, if the request type is classified as “Linked Account Deposit,” the system can automatically trigger a “Source Verification” protocol. The protocol can include, for example, parsing the incoming transaction metadata to confirm that the routing and account number of the originating bank match the stored credentials of the pre-verified linked external account. If the source data does not match (e.g., the funds are coming from an unverified third-party bank), the protocol can return a failure signal.

As another example, if the request type is classified as “Parallel Ingress Deposit” (targeting a parallel intermediate account or SDN), the system can bypass the source verification protocol used for linked accounts and instead executes the “Debit Blocking” and “Payor Mapping” protocols. The “Debit Blocking” protocol can analyze the transaction code to verify the request is strictly a credit (deposit). If the analysis identifies a debit (withdrawal) code, the protocol can immediately trigger a denial. Simultaneously, the “Payor Mapping” protocol can check if the incoming source entity matches the specific third-party entity (e.g., “Employer X”) mapped to that unique SDN in the system’s database.

The system 100 also modulates the execution of these protocols based on the status of the secure account determined in operation 208. For example, if the status is “PROTECTED,” the system can execute the suite of protocols described above. However, if the status is “LOCKDOWN,” the system may instead execute an override protocol that preemptively fails specific request types. For example, while a deposit request might still be processed through the standard protocols during a lockdown, any request type involving a transfer out of the secure account (e.g., “Linked Account Withdrawal”) would be subjected to a “Lockdown Enforcement” protocol that forces a failure decision output regardless of other valid credentials.

Additionally, the system can execute other risk management protocols. These can include transaction monitoring to ensure the request adheres to velocity limits (e.g., maximum of 5 transactions per day) and transaction caps (e.g., maximum of $50,000 per transfer).

The system can execute security protocols in parallel or in sequence.

As described above, in some cases, when the system executes the one or more security protocols, the system identifies that the funds transfer request directed to the parallel intermediate account is a debit request. For example, the system can inspect the specific transaction codes or instruction types within the funds transfer request metadata to distinguish between an instruction to credit funds to the account (a deposit) and an instruction to debit funds from the account (a withdrawal).

The system, in response to failing at least one of the one or more security protocols, generates a respective decision output for the funds transfer request (operation 212).

In some cases, the decision output for the funds transfer request is a decision output that denies the funds transfer request.

For example, if the system determines that a “Linked Account Withdrawal” request originates from a device with an unrecognized fingerprint or IP address that does not match the secure account owner’s profile, the system generates a denial output to block the transaction.

As another example, if a “Linked Account Deposit” request attempts to transfer funds from an external bank account that is not listed in the system’s pre-verified database of linked external accounts, the system generates a denial output.

In some cases, the decision output for the funds transfer request is a decision output that defers the funds transfer request for review.

For example, if a “Wire Transfer” request exceeds a typical transaction velocity limit but passes all other authentication checks, the system may place the funds transfer request in a “Pending Review” state, triggering a manual verification alert to a fraud analyst before a final approval or denial is issued.

In some cases, when the system identifies that the funds transfer request directed to the parallel intermediate account is a debit request, the system generates a decision output that denies the funds transfer request.

In some implementations, in response to passing all the one or more security protocols, the system generates a respective decision output that allows the funds transfer request.

For example, if the user initiates a transfer from their linked external account (Linked Account Deposit), and the system confirms the source account matches the stored linked account credentials and the secure account status is "PROTECTED," the system generates an allowance output to process the inbound transfer.

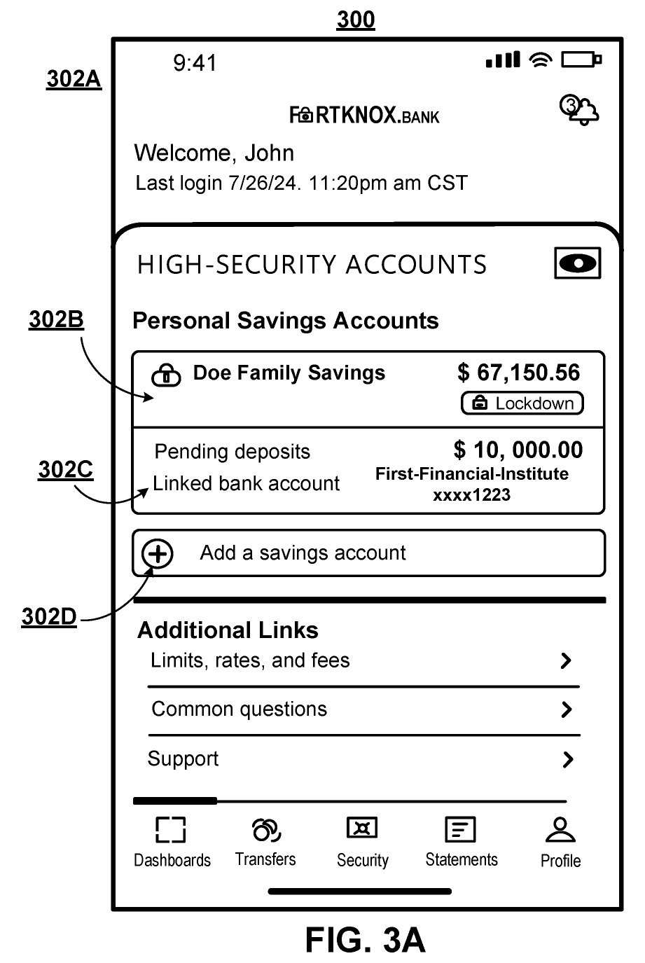

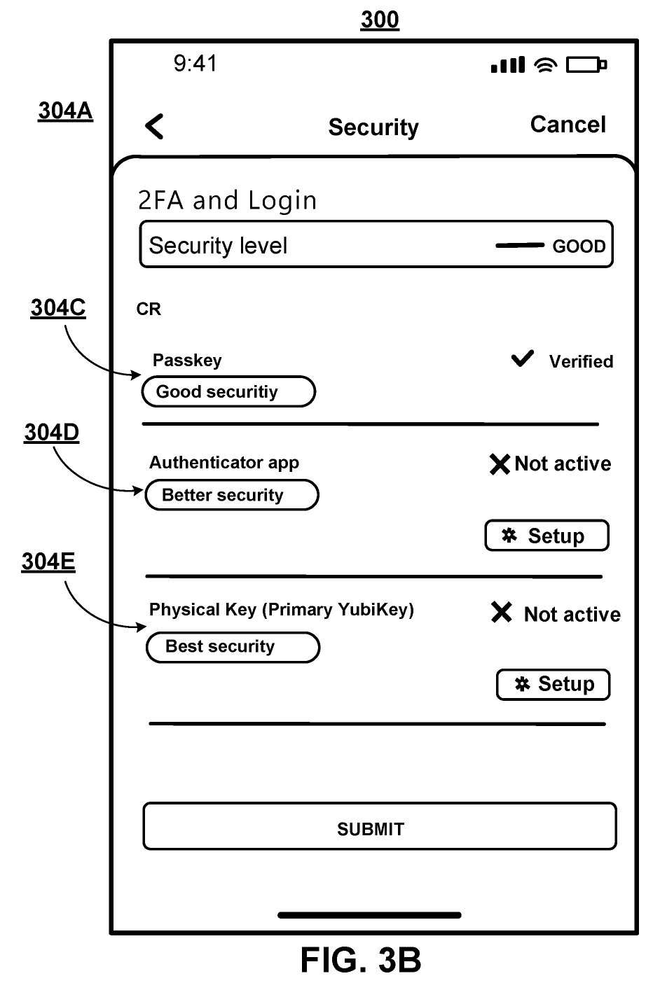

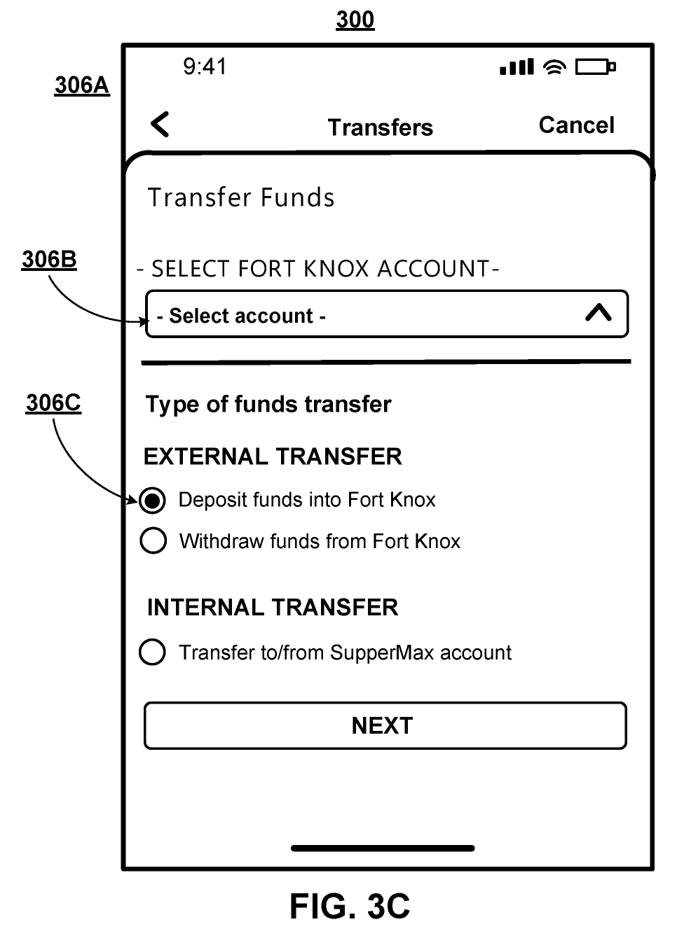

FIG. 3A shows an example 302A, of a user interface displays.

FIG. 3B shows an example 304A, of a user interface displays.

FIG. 3C shows an example 306A, of a user interface displays.

In particular, user interface displays 302A, 304A, 306A are example displays for a smartphone application.

In this example interface, the label “Fort Knox” is used as a user-facing identifier for the Secure Account. Accordingly, the option “Deposit funds into Fort Knox” corresponds to a request to transfer funds from the External Account to the Secure Account.

Display 302A illustrates a secure account 302B with the identifier “Doe Family Savings”, a linked external account 302C with the identifier FIRST-FINANCIAL-INSTITUTION xxxx1223, and a touch screen button 302D labeled as “Add a savings account” that would allow a user to trigger the system to establish a secure link to an external account.

Display 304A illustrates user-customizable security protocol options for protecting transactions associated with the accounts. In particular, display 304A shows two factor authentication options that include a passkey protocol 304C, an authenticator application protocol 304D, and a physical key protocol 304E.

Additionally, the display presents a ‘Security level’ indicator (e.g., ‘Good’, ‘Critical’) which visually represents the determined ‘status’ of the secure account as described in operation 208 of FIG. 2. For example, a ‘Good’ security level may correspond to a ‘PROTECTED’ status, while a ‘Critical’ level may correspond to a ‘LOCKDOWN’ status.

Display 306A illustrates a display for a user to initiate transfer of funds. The display shows a dropdown option 306B to select the secure account participating in the funds transfer, and circle options to indicate the funds transfer request type (e.g., display 306A shows funds transfer request type “EXTERNAL TRANSFER: Deposit funds into Fort Knox” is selected).

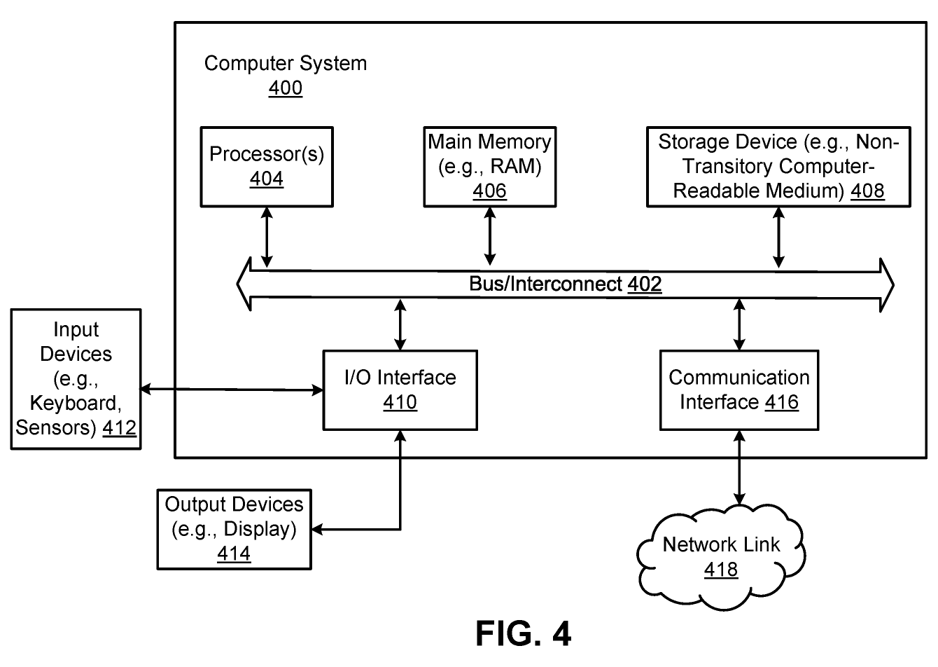

FIG. 4 shows an example computer system 400. The example computer system 400 is one in which embodiments of the present disclosure may be implemented.

For a system of one or more computers to be configured to perform particular operations or actions means that the system 400 has installed on it: software, firmware, hardware (e.g., processor 404 coupled to bus 402), or a combination of them that in operation cause the system 400 to perform the operations or actions. For one or more computer programs to be configured to perform particular operations or actions means that the one or more programs include instructions that, when executed by data processing apparatus, such as processor 404, cause the apparatus to perform the operations or actions. Embodiments of the subject matter and the functional operations described in this specification (e.g., processor 404, main memory 406, storage device 408, I/O interface 410, and communication interface 416) can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus (e.g., processor 404). The computer storage medium can be a machine-readable storage device 408, a machine-readable storage substrate, a random or serial access memory device (such as main memory 406), or a combination of one or more of them. The computer system 400 may further include input device 412 (e.g., keyboards, sensor) and output devices 414 (e.g., displays, actuators) connected via the I/O interface 410. Alternatively, or in addition, the program instructions can be encoded on an artificially generated propagated signal, e.g., a machine-generated electrical, optical, or electromagnetic signal, which is generated to encode information for transmission (e.g., via communication interface 416 over network link 418) to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification, the different functions can be implemented using “engines,” which broadly refer to software-based systems, subsystems, or processes that are programmed to perform one or more specific functions. Generally, an engine is implemented as one or more software modules or components, installed on one or more computers, in one or more locations. In some cases, one or more computers can be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing models described in this specification can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any disclosure or on the scope of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claim in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

### EXAMPLES

Although the present application is defined in the attached claims, it should be understood that the present invention can also be (alternatively) defined in accordance with the following examples:

Example 1: A method performed by one or more computers, the method comprising:
maintaining data associating each of a plurality of funds transfer request types and a status of a secure account with a respective plurality of security protocols;
receiving one or more funds transfer requests to transfer funds among the secure account, one or more intermediate accounts, and an external account, wherein funds transfer occurs between at least one first account and at least one second account, wherein the at least one first account and at least one second account are distinct;
for each funds transfer request,
   determining a funds transfer request type for the funds transfer request;
      determining a status for the secure account;
      in response to determining the funds transfer request type and the status of the secure account, executing one or more security protocols using the funds transfer request and the status of the secure account, wherein the one or more security protocols are retrieved by querying the maintained data; and
      in response to failing at least one of the one or more security protocols, generating a respective decision output for the funds transfer request.

Example 2: The method of Example 1, wherein the decision output for the funds transfer request is a decision output that denies the funds transfer request.

Example 3: The method of any one of the previous Examples, wherein the decision output for the funds transfer request is a decision output that defers the funds transfer request for review.

Example 4: The method of any one of the previous Examples, further comprising:
in response to passing all the one or more security protocols, generating a respective decision output that allows the funds transfer request.

Example 5: The method of any one of the previous Examples, wherein the external account is continuously monitored for security triggers, the method further comprising:
in response to detecting a security trigger for the external account, updating the status of the secure account.

Example 6: The method of any one of the previous Examples, wherein the one or more intermediate accounts comprises a linked intermediate account associated with the external account and a parallel intermediate account distinct from the linked intermediate account.

Example 7: The method of Example 6, wherein receiving the one or more funds transfer requests comprises receiving a deposit request directed to the parallel intermediate account from a source distinct from the external account.

Example 8: The method of Example 6, wherein receiving the one or more funds transfer requests comprises receiving a debit request directed to the parallel intermediate account from a source distinct from the external account;
wherein determining the funds transfer request type for the funds transfer request comprises identifying that the funds transfer request directed to the parallel intermediate account is the debit request;
wherein the one or more security protocols comprise verifying that the funds transfer request is not the debit request directed to the parallel intermediate account; and
wherein in response to failing at least one of the one or more security protocols, generating a respective decision output for the funds transfer request comprises generating a decision output that denies the debit request.

Example 9: The method of Example 6, comprising:
generating a unique account identifier associated with the parallel intermediate account; and mapping the unique account identifier to a specific third-party entity.

Example 10: The method of any one of examples 6 to 9, comprising:
generating a plurality of unique account identifiers associated with the parallel intermediate account; and
mapping each of the plurality of unique account identifiers to a different third-party entity.

Example 11: The method of any one of Examples 6 to 10, comprising:
detecting a receipt of funds in the parallel intermediate account; and
automatically generating a transfer request to move the funds from the parallel intermediate account to the secure account.

Example 12: A system comprising:
one or more computers; and
one or more storage devices communicatively coupled to the one or more computers, wherein the one or more storage devices store instructions that, when executed by the one or more computers, cause the one or more computers to perform operations according to any one of the methods of Examples 1 to 11.

Example 13: A non-transitory, computer-readable medium storing one or more instructions executable by a computer system to perform operations according to any one of the methods of Examples 1 to 11.

What is claimed is:

1. A method performed by one or more computers, the method comprising:
maintaining data associating each of a plurality of funds transfer request types and a status of a secure account with a respective plurality of security protocols;
receiving one or more funds transfer requests to transfer funds among the secure account, one or more intermediate accounts, and an external account, wherein funds transfer occurs between at least one first account and at least one second account, wherein the at least one first account and at least one second account are distinct; and
for each funds transfer request,
determining a funds transfer request type for the funds transfer request;
determining a status for the secure account;
in response to determining the funds transfer request type and the status of the secure account, executing one or more security protocols using the funds transfer request and the status of the secure account, wherein the one or more security protocols are retrieved by querying the maintained data; and
in response to failing at least one of the one or more security protocols, generating a respective decision output for the funds transfer request.

2. The method of claim 1, wherein the decision output for the funds transfer request is a decision output that denies the funds transfer request.

3. The method of claim 1, wherein the decision output for the funds transfer request is a decision output that defers the funds transfer request for review.

4. The method of claim 1, further comprising:
in response to passing all the one or more security protocols, generating a respective decision output that allows the funds transfer request.

5. The method of claim 1, wherein the external account is continuously monitored for security triggers, the method further comprising:
in response to detecting a security trigger for the external account, updating the status of the secure account.

6. The method of claim 1, wherein the one or more intermediate accounts comprises a linked intermediate account associated with the external account and a parallel intermediate account distinct from the linked intermediate account.

7. The method of claim 6, wherein receiving the one or more funds transfer requests comprises receiving a deposit request directed to the parallel intermediate account from a source distinct from the external account.

8. The method of claim 6, wherein receiving the one or more funds transfer requests comprises receiving a debit request directed to the parallel intermediate account from a source distinct from the external account;
wherein determining the funds transfer request type for the funds transfer request comprises identifying that the funds transfer request directed to the parallel intermediate account is the debit request;
wherein the one or more security protocols comprise verifying that the funds transfer request is not the debit request directed to the parallel intermediate account; and
wherein in response to failing at least one of the one or more security protocols, generating a respective decision output for the funds transfer request comprises generating a decision output that denies the debit request.

9. The method of claim 6, further comprising:
generating a unique account identifier associated with the parallel intermediate account; and
mapping the unique account identifier to a specific third-party entity.

10. The method of claim 6, further comprising:
generating a plurality of unique account identifiers associated with the parallel intermediate account; and
mapping each of the plurality of unique account identifiers to a different third-party entity.

11. The method of claim 6, further comprising:
detecting a receipt of funds in the parallel intermediate account; and
automatically generating a transfer request to move the funds from the parallel intermediate account to the secure account.

12. A system comprising:
one or more computers; and
one or more storage devices communicatively coupled to the one or more computers, wherein the one or more storage devices store instructions that, when executed by the one or more computers, cause the one or more computers to perform operations, the operations comprising:
maintaining data associating each of a plurality of funds transfer request types and a status of a secure account with a respective plurality of security protocols; receiving one or more funds transfer requests to transfer funds among the secure account, one or more intermediate accounts, and an external account, wherein funds transfer occurs between at least one first account and at least one second account, wherein the at least one first account and at least one second account are distinct; and
for each funds transfer request,
determining a funds transfer request type for the funds transfer request;
determining a status for the secure account;
in response to determining the funds transfer request type and the status of the secure account, executing one or more security protocols using the funds transfer request and the status of the secure account; and
in response to failing at least one of the one or more security protocols, generating a respective decision output for the funds transfer request.

13. The system of claim 12, wherein the decision output for the funds transfer request is a decision output that denies the funds transfer request.

14. The system of claim 12, wherein the decision output for the funds transfer request is a decision output that defers the funds transfer request for review.

15. The system of claim 12, wherein the operations further comprise:
in response to passing all the one or more security protocols, generating a respective decision output that allows the funds transfer request.

16. The system of claim 12, wherein the external account is continuously monitored for security triggers, the method further comprising:
in response to detecting a security trigger for the external account, updating the status of the secure account.

17. The system of claim 12, wherein the one or more intermediate accounts comprises a linked intermediate account associated with the external account and a parallel intermediate account distinct from the linked intermediate account.

18. The system of claim 17, wherein receiving the one or more funds transfer requests comprises receiving a deposit request directed to the parallel intermediate account from a source distinct from the external account.

19. The system of claim 17, wherein receiving the one or more funds transfer requests comprises receiving a debit request directed to the parallel intermediate account from a source distinct from the external account;
wherein determining the funds transfer request type for the funds transfer request comprises identifying that the funds transfer request directed to the parallel intermediate account is the debit request;
wherein the one or more security protocols comprise verifying that the funds transfer request is not the debit request directed to the parallel intermediate account;
and wherein in response to failing at least one of the one or more security protocols, generating a respective decision output for the funds transfer request comprises generating a decision output that denies the debit request.

20. One or more non-transitory computer storage media storing instructions that when executed by one or more computers cause the one or more computers to perform operations, the operations comprising:
maintaining data associating each of a plurality of funds transfer request types and a status of a secure account with a respective plurality of security protocols; receiving one or more funds transfer requests to transfer funds among the secure account, one or more intermediate accounts, and an external account, wherein funds transfer occurs between at least one first account and at least one second account, wherein the at least one first account and at least one second account are distinct; and
for each funds transfer request,
determining a funds transfer request type for the funds transfer request;
determining a status for the secure account;
in response to determining the funds transfer request type and the status of the secure account, executing one or more security protocols using the funds transfer request and the status of the secure account;
and in response to failing at least one of the one or more security protocols, generating a respective decision output for the funds transfer request.
